(19) United States
(12) Patent Application Publication
(10) Pub. No.: US 2018/0260473 A1
(43) Pub. Date: Sep. 13, 2018

(54) FULL TEXT RETRIEVING AND MATCHING METHOD AND SYSTEM BASED ON LUCENE CUSTOM LEXICON

(71) Applicant: WUHAN DOUYU NETWORK TECHNOLOGY CO., LTD., WUHAN (CN)

(72) Inventor: Fan BAI, WUHAN (CN)

(73) Assignee: WUHAN DOUYU NETWORK TECHNOLOGY CO., LTD., WUHAN (CN)

(21) Appl. No.: 15/771,057

(22) PCT Filed: Apr. 17, 2017
(86) PCT No.: PCT/CN2017/080784

§ 371 Date: Apr. 25, 2018

(30) Foreign Application Priority Data
May 16, 2016 (CN) 201610321306.6

(51) Int. Cl. G06F 17/30

(52) U.S. Cl. CPC G06F 17/30663; G06F 17/30737; G06F 17/30666; G06F 17/30705; G06F 17/30648

(57) ABSTRACT

The present invention discloses a full text retrieving and matching method and system based on a Lucene custom lexicon, and relates to the field of big data search. The method includes the following steps: obtaining a search terms inputted by a user in real time in a Lucene search environment, and detecting whether a result is searched; removing a special character from the search terms and then storing the search terms in the Lucene custom lexicon, if the result is not searched; performing word segmentation processing on the search terms, if the result is searched; continuing to search several word segmented word groups, and detecting whether a result is searched; removing the special character from the word segmented word group for which the result cannot be searched and then storing the word group in the Lucene custom lexicon, if the result is not searched; and recording a search time, a word segmented search terms and a search feedback information, and finally establishing the Lucene custom lexicon supporting Lucene full text retrieval, if the result is searched for the several word segmented word groups. With the method, a ones' own dedicated Lucene custom lexicon can be established quickly and effectively according to the search terms inputted by the user.

### FIELD OF THE INVENTION

The present invention relates to the field of big data search, and in particular to a full text retrieving and matching method and system based on a Lucene custom lexicon.

### BACKGROUND OF THE INVENTION

Apache Lucene is a full text retrieval engine toolkit with open source codes, but it is not a complete full text retrieval engine, but an architecture of a full text retrieval engine, which provides a complete query engine and indexing engine as well as a partial text analysis engine.

For the convenience of understanding of readers, related terms are simply illustrated below at first:

Apache Lucene refers to an open source full text retrieval project under Apache; a full text retrieval is different from a traditional fuzzy matching, and means that word segmentation is first performed on a search terms in accordance with a certain rule, the segmented words are matched with source data, and then scoring is performed according to data such as occurrence times of the segmented words, adjacent distances of the segmented words, weights and the like to obtain a retrieval result; a segmented word means a full text retrieval index, for example: I am a Chinese, the segmented words thereof can be: I, am, China, people, Chinese and so on; a public lexicon refers to a lexicon for storing rules for public word segmentation, for example, commonly used hello, China and the like; a custom lexicon refers to a dictionary lexicon for storing one's needed rules for word segmentation according to ones' own needs; a search feedback means a feedback for search effect, that is, after a user inputs a search terms to enter a search page, whether the user clicks a page link on the search page or a link after multiple page turnings; a search volume means a search volume of a certain search terms within a time period throughout a website; and a field refers to a field needed to be searched, for example, a game name, anchor name, room name and the like.

In Apache Lucene full text retrieval, it needs to perform word segmentation on a source data. If a word segmentation processing is not performed on a specific word group, the word group cannot be retrieved. For example, as for the search in the field of game live broadcast, “League of Legends”, “Dota2” and “Hearthstone” and the like that substantially do not occur in the public lexicon are very difficult to be retrieved. Therefore, it is an important difficulty in the field of full text retrieval how to obtain the most necessary retrieval words of the user and generate a custom lexicon.

### SUMMARY OF THE INVENTION

In order to overcome the shortcomings in the above background art, the present invention provides a full text retrieving and matching method and system based on a Lucene custom lexicon which are capable of establishing quickly and effectively a ones' own dedicated Lucene custom lexicon according to a search terms input by a user.

The present invention provides a full text retrieving and matching method based on a Lucene custom lexicon, including the following steps: obtaining a search terms inputted by a user in real time in a search environment based on a Lucene full text retrieval engine, and detecting whether a result is searched; removing a special character from the search terms for which the result cannot be searched and then storing the search terms in the Lucene custom lexicon, if the result is not searched; performing word segmentation processing on the search terms for which the result is searched to obtain several word segmented word groups, if the result is searched; continuing to search the several word segmented word groups, and detecting whether a result is searched; removing the special character from the word segmented word group for which the result cannot be searched and then storing the word group in the Lucene custom lexicon, if the result is not searched; and recording a search time, a word segmented search terms and a search feedback information, and finally establishing the Lucene custom lexicon supporting Lucene full text retrieval, if the result is searched for the several word segmented word groups.

On the basis of the above-mentioned technical solution, after the establishing the Lucene custom lexicon supporting Lucene full text retrieval, the method further comprises the following steps: periodically calculating values of field weights in accordance with a dynamic field weight allocation formula, according to a search volume, the search feedback information and custom weight variable linear superposition of fields, on the basis of establishing the Lucene custom lexicon supporting Lucene full text retrieval; and dynamically assigning the calculated values of field weights to the fields via a weight setting interface of the Lucene full text retrieval engine.

On the basis of the above-mentioned technical solution, the dynamic field weight allocation formula is:

boost=(α*n+β*m+δ*In(t)+r)*ρ,

wherein, boost represents a value of a weight of a certain field, n represents a search volume of the field at a certain time period, m represents a total amount of complete search feedback of the field after retrieved at the certain time period, t represents a total amount of incomplete search feedback of the field after retrieved at the certain time period, r represents a custom weight variable, α represents a coefficient factor of the search volume, β represents a coefficient factor of complete search feedback, δ represents a coefficient factor of incomplete search feedback, and ρ represents a global coordination coefficient factor.

On the basis of the above-mentioned technical solution, the custom weight variable is an anchor name, an anchor room name or a room type.

On the basis of the above-mentioned technical solution, in the case of system transformation or a change of user's search preference, the custom weight variable changes accordingly.

The present invention further provides a full text retrieving and matching system based on a Lucene custom lexicon, including a Lucene custom lexicon establishment unit, wherein the Lucene custom lexicon establishment unit is used for establishing the Lucene custom lexicon supporting Lucene full text retrieval and configured for: obtaining a search terms inputted by a user in real time in a search environment based on a Lucene full text retrieval engine, and detecting whether a result is searched; removing a special character from the search terms for which the result cannot be searched and then storing the search terms in the Lucene custom lexicon, if the result is not searched; performing word segmentation processing on the search terms for which the result is searched to obtain several word segmented word groups, if the result is searched; continuing to search the several word segmented word groups, and detecting whether a result is searched; removing the special character from the word segmented word group for which the result cannot be searched and then storing the word group in the Lucene custom lexicon, if the result is not searched; and recording a search time, a word segmented search terms and a search feedback information, if the result is searched for the several word segmented word groups.

On the basis of the above-mentioned technical solution, the system further includes a dynamic field weight allocation unit, wherein the dynamic field weight allocation unit is used for dynamically allocating field weights and configured for: periodically calculating values of field weights in accordance with a dynamic field weight allocation formula, according to a search volume, the search feedback information and custom weight variable linear superposition of fields, on the basis of the Lucene custom lexicon; and dynamically assigning the calculated values of field weights to the fields via a weight setting interface of the Lucene full text retrieval engine.

On the basis of the above-mentioned technical solution, the dynamic field weight allocation formula is:

boost=(α*n+β*m+δ*In(t)+r)*ρ,

wherein, boost represents a value of a weight of a certain field, n represents a retrieval volume of the field at a certain time period, m represents a total amount of complete search feedback of the field after retrieved at the certain time period, t represents a total amount of incomplete search feedback of the field after retrieved at the certain time period, r represents a custom weight variable; α represents a coefficient factor of the retrieval volume, β represents a coefficient factor of complete search feedback, δ represents a coefficient factor of incomplete search feedback, and ρ represents a global coordination coefficient factor.

On the basis of the above-mentioned technical solution, the custom weight variable is an anchor name, an anchor room name or a room type.

On the basis of the above-mentioned technical solution, in the case of system transformation or a change of user's search preference, the custom weight variable changes accordingly.

Compared with the prior art, the present invention has the following advantages:

(1) the method of the present invention may, in a search environment based on a Lucene full text retrieval engine, establish the Lucene custom lexicon for Lucene full text retrieval. The method of the present invention may further obtain a search terms inputted by a user in real time in a search environment based on a Lucene full text retrieval engine, and detect whether a result is searched; remove a special character from the search terms for which the result cannot be searched and then store the search terms in the Lucene custom lexicon, if the result is not searched; perform word segmentation processing on the search terms for which the result is searched to obtain several word segmented word groups, if the result is searched; continue to search the several word segmented word groups, and detect whether a result is searched; remove the special character from the word segmented word group for which the result cannot be searched and then store the word group in the Lucene custom lexicon, if the result is not searched; and record a search time, a word segmented search terms and a search feedback information, if the result is searched for the several word segmented word groups. With the present invention, a ones' own dedicated Lucene custom lexicon can be established quickly and effectively according to a search terms input by a user, and a Lucene custom lexicon satisfying a current search environment is formed for the Lucene full text retrieval, thereby a better search effect can be achieved. For example, as for game live broadcast, the user could prefer to search information about “YYF”, “55 open”, “Dog” and the like, but the conventional lexicon cannot satisfy such requirements. With the method in accordance with an embodiment of the present invention, an optimal result may be not obtained upon the first search. However, as the Lucene custom lexicon updates continuously and iteratively, the search result is gradually optimized with an increase of the search volume of the user.

(2) On the basis of the Lucene custom lexicon, the present invention dynamically allocates the field weights. The present invention may further periodically calculate values of field weights in accordance with a dynamic field weight allocation formula, according to a search volume, the search feedback information and custom weight variable linear superposition of fields, on the basis of the Lucene custom lexicon; and dynamically assign the calculated values of field weights to the fields via a weight setting interface (setboost) of the Lucene full text retrieval engine, thereby capable of allocating stably and effectively weights of various fields. In the case of system transformation or a change of user's search preference, a custom weight variable changes accordingly. For example, the search system has the following several fields: an anchor name, an anchor room name and a room type. The system places particular emphasis on the search of the anchor name at the beginning, then only a custom weight needs to be increased, that is, the custom weight variable in the dynamic field weight allocation formula needs to be increased.

### BRIEF DESCRIPTION OF THE DRAWINGS

FIG. 1 is a flowchart of a full text retrieving and matching method based on a Lucene custom lexicon according to an embodiment of the present invention.

### DETAILED DESCRIPTION OF THE EMBODIMENTS

The present invention is further described in detail in combination with the drawings and specific embodiments below.

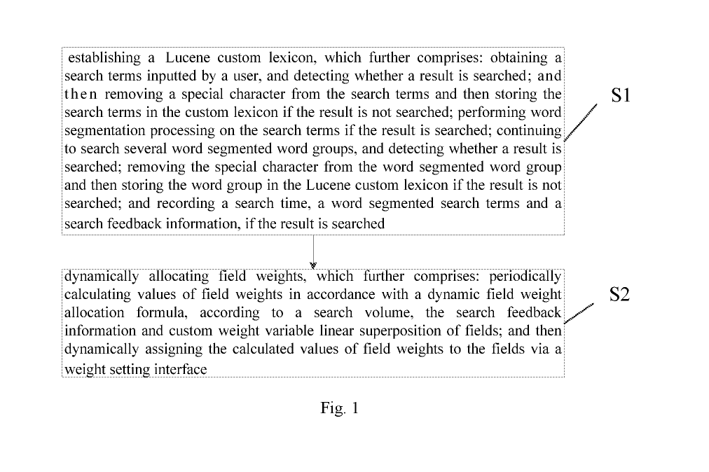

Referring to FIG. 1, an embodiment of the present invention provides a full text retrieving and matching method based on a Lucene custom lexicon, including the following steps:

S1. establishing the Lucene custom lexicon supporting Lucene full text retrieval, which further comprises: obtaining a search terms inputted by a user in real time in a search environment based on a Lucene full text retrieval engine, and detecting whether a result is searched; removing a special character from the search terms for which the result cannot be searched and then storing the search terms in the Lucene custom lexicon, if the result is not searched; performing word segmentation processing on the search terms for which the result is searched to obtain several word segmented word groups, if the result is searched; continuing to search the several word segmented word groups, and detecting whether a result is searched; removing the special character from the word segmented word group for which the result cannot be searched and then storing the word group in the Lucene custom lexicon, if the result is not searched; and recording a search time, a word segmented search terms and a search feedback information, and finally establishing the Lucene custom lexicon supporting Lucene full text retrieval, if the result is searched for the several word segmented word groups; and

S2: dynamically allocating field weights, which further comprises: periodically calculating values of field weights in accordance with a dynamic field weight allocation formula, according to a search volume, the search feedback information and custom weight variable linear superposition of fields, on the basis of establishing the Lucene custom lexicon supporting Lucene full text retrieval; and then dynamically assigning the calculated values of field weights to the fields via a weight setting interface (setboost) of the Lucene full text retrieval engine.

The dynamic field weight allocation formula is:

boost=(α*n+β*m+δ*In(t)+r)*ρ,

wherein, boost represents wherein, boost represents a value of a weight of a certain field, n represents a retrieval volume of the field at a certain time period, m represents a total amount of complete search feedback of the field after retrieved at the certain time period, t represents a total amount of incomplete search feedback of the field after retrieved at the certain time period, r represents a custom weight variable, for example, an anchor name, an anchor room name, a room type; α represents a coefficient factor of the retrieval volume, β represents a coefficient factor of complete search feedback, δ represents a coefficient factor of incomplete search feedback, and ρ represents a global coordination coefficient factor.

The custom weight variable may be the anchor name, the anchor room name or the room type, and the custom weight variable changes accordingly in the case of system transformation or a change of user's search preference.

An embodiment of the present invention further provides a full text retrieving and matching system based on a Lucene custom lexicon, the system includes a Lucene custom lexicon establishment unit and a dynamic field weight allocation unit.

The Lucene custom lexicon establishment unit is used for establishing the Lucene custom lexicon supporting Lucene full text retrieval, and configured for: obtaining a search terms inputted by a user in real time in a search environment based on a Lucene full text retrieval engine, and detecting whether a result is searched; removing a special character from the search terms for which the result cannot be searched and then storing the search terms in the Lucene custom lexicon, if the result is not searched; performing word segmentation processing on the search terms for which the result is searched to obtain several word segmented word groups, if the result is searched; continuing to search the several word segmented word groups, and detecting whether a result is searched; removing the special character from the word segmented word group for which the result cannot be searched and then storing the word group in the Lucene custom lexicon, if the result is not searched; and recording a search time, a word segmented search terms and a search feedback information, if the result is searched for the several word segmented word groups.

The dynamic field weight allocation unit is used for dynamically allocating field weights, and configured for: periodically calculating values of field weights in accordance with a dynamic field weight allocation formula, according to a search volume, the search feedback information and custom weight variable linear superposition of fields, on the basis of establishing the Lucene custom lexicon supporting Lucene full text retrival; and dynamically assigning the calculated values of field weights to the fields via a weight setting interface (setboost) of the Lucene full text retrieval engine.

The dynamic field weight allocation formula is:

boost=(α*n+β*m+δ*In(t)+r)*ρ,

wherein, boost represents a value of a weight of a certain field, n represents a retrieval volume of the field at a certain time period, m represents a total amount of complete search feedback of the field after retrieved at the certain time period, t represents a total amount of incomplete search feedback of the field after retrieved at the certain time period, r represents a custom weight variable, for example, an anchor name, an anchor room name, a room type; α represents a coefficient factor of the retrieval volume, β represents a coefficient factor of complete search feedback, δ represents a coefficient factor of incomplete search feedback, and ρ represents a global coordination coefficient factor.

The custom weight variable may be the anchor name, the anchor room name or the room type, and the custom weight variable changes accordingly in the case of system transformation or a change of user's search preference.

With an embodiment of the present invention, a ones' own dedicated Lucene custom lexicon can be established quickly and effectively according to a condition input by a user, and the Lucene custom lexicon satisfying a current search environment is formed for the Lucene full text retrieval, thereby a better search effect can be achieved.

For example, as for game live broadcast, the user could prefer to search information about “YYF”, “55 open”, “Dog” and the like, but the conventional lexicon cannot satisfy such requirements. With the method in accordance with an embodiment of the present invention, an optimal result may be not obtained upon the first search. However, as the Lucene custom lexicon updates continuously and iteratively, the search result is gradually optimized with an increase of the search volume of the user.

In addition, in a search system, some constant is often assigned to a weight, such setting might obtain a good search result at some time period. However, with a transformation of the system, and a change of preference of a population of users or a change of source data or other factors, it is difficult for such setting to obtain an accurate result. In a multi-field retrieval, it needs to be seriously considered by those skilled in the art in that how to dynamically allocate the field weights according to a search feedback effect, the search volume and other factors to achieve an optimal matching result.

For example, the users in a search system are just interested in some several anchors at the beginning, then they pay more attention to the search results of anchor names, thus the search volume of the anchor names in the system may be increased, a search feedback result may become the best, and the weight assigned to this field may also dynamically increase. However, with a gradual understanding of the users on the system, they pay more attention to contents of rooms, then the search volume thereof may be increased accordingly and the feedback result may become more better, therefore of course, the weights assigned to the room name and room type may also increase.

In the case of system transformation or a change of user's search preference, a custom weight variable changes accordingly. For example, the search system has the following several fields: an anchor name, an anchor room name and a room type. The system places particular emphasis on the search of the anchor name at the beginning, then only a custom weight needs to be increased, that is, the custom weight variable in the dynamic field weight allocation formula needs to be increased.

Those skilled in the art can make various modifications and variations to the embodiments of the present invention. If these modifications and variations are within the scope of the claims of the present invention and the equivalent techniques thereof, these modifications and variations also fall within the protection scope of the present invention.

Contents, not described in the specification in detail, are the prior art well-known to those skilled in the art.

1. A full text retrieving and matching method based on a Lucene custom lexicon, comprising the following steps:
obtaining a search terms inputted by a user in real time in a search environment based on a Lucene full text retrieval engine, and detecting whether a result is searched;
removing a special character from the search terms for which the result cannot be searched and then storing the search terms in the Lucene custom lexicon, if the result is not searched;
performing word segmentation processing on the search terms for which the result is searched to obtain several word segmented word groups, if the result is searched;
continuing to search the several word segmented word groups, and detecting whether a result is searched;
removing the special character from the word segmented word group for which the result cannot be searched and then storing the word group in the Lucene custom lexicon, if the result is not searched; and
recording a search time, a word segmented search terms and a search feedback information, and finally establishing the Lucene custom lexicon supporting Lucene full text retrieval, if the result is searched for the several word segmented word groups.

2. The full text retrieving and matching method based on a Lucene custom lexicon of claim 1, wherein after the establishing the Lucene custom lexicon supporting Lucene full text retrieval, the method further comprises the following steps:
periodically calculating values of field weights in accordance with a dynamic field weight allocation formula, according to a search volume, the search feedback information and custom weight variable linear superposition of fields, on the basis of establishing the Lucene custom lexicon supporting Lucene full text retrieval; and
dynamically assigning the calculated values of field weights to the fields via a weight setting interface of the Lucene full text retrieval engine.

3. The full text retrieving and matching method based on a Lucene custom lexicon of claim 2, wherein the dynamic field weight allocation formula is:
boost=(α*n+βm+δ*In(t)+r)*ρ,
wherein, boost represents a value of a weight of a certain field, n represents a search volume of the field at a certain time period, m represents a total amount of complete search feedback of the field after retrieved at the certain time period, t represents a total amount of incomplete search feedback of the field after retrieved at the certain time period, r represents a custom weight variable, α represents a coefficient factor of the search volume, β represents a coefficient factor of complete search feedback, δ represents a coefficient factor of incomplete search feedback, and ρ represents a global coordination coefficient factor.

4. The full text retrieving and matching method based on a Lucene custom lexicon of claim 3, wherein the custom weight variable is an anchor name, an anchor room name or a room type.

5. The full text retrieving and matching method based on a Lucene custom lexicon of claim 4, wherein the custom weight variable changes accordingly in the case of system transformation or a change of user's search preference.

6. A full text retrieving and matching system based on a Lucene custom lexicon, comprising a Lucene custom lexicon establishment unit for establishing the Lucene custom lexicon supporting Lucene full text retrieval, wherein the Lucene custom lexicon establishment unit is configured for:
obtaining a search terms inputted by a user in real time in a search environment based on a Lucene full text retrieval engine, and detecting whether a result is searched;
removing a special character from the search terms for which the result cannot be searched and then storing the search terms in the Lucene custom lexicon, if the result is not searched;
performing word segmentation processing on the search terms for which the result is searched to obtain several word segmented word groups, if the result is searched;
continuing to search the several word segmented word groups, and detecting whether a result is searched;
removing the special character from the word segmented word group for which the result cannot be searched and then storing the word group in the Lucene custom lexicon, if the result is not searched; and
recording a search time, a word segmented search terms and a search feedback information, if the result is searched for the several word segmented word groups.

7. The full text retrieving and matching system based on a Lucene custom lexicon of claim 6, wherein the system further comprises a dynamic field weight allocation unit for dynamically allocating field weights, wherein the dynamic field weight allocation unit is configured for:
periodically calculating values of field weights in accordance with a dynamic field weight allocation formula, according to a search volume, the search feedback information and custom weight variable linear superposition of fields, on the basis of the Lucene custom lexicon; and
dynamically assigning the calculated values of field weights to the fields via a weight setting interface of the Lucene full text retrieval engine.

8. The full text retrieving and matching system based on a Lucene custom lexicon of claim 7, wherein the dynamic field weight allocation formula is:
boost=(α*n+β*m+δ*In(t)+r)*ρ,
wherein, boost represents a value of a weight of a certain field, n represents a search volume of the field at a certain time period, m represents a total amount of complete search feedback of the field after retrieved at the certain time period, t represents a total amount of incomplete search feedback of the field after retrieved at the certain time period, r represents a custom weight variable; α represents a coefficient factor of the search volume, β represents a coefficient factor of complete search feedback, δ represents a coefficient factor of incomplete search feedback, and ρ represents a global coordination coefficient factor.

9. The full text retrieving and matching system based on a Lucene custom lexicon of claim 8, wherein the custom weight variable is an anchor name, an anchor room name or a room type.

10. The full text retrieving and matching system based on a Lucene custom lexicon of claim 9, wherein, the custom weight variable changes accordingly in the case of system transformation or a change of user's search preference.
